(19) United States
(12) Patent Application Publication
(10) Pub. No.: US 2024/0016126 A1
(43) Pub. Date: Jan. 18, 2024

(54) PET LEASH HANDLE

(71) Applicants: Jennifer Velasquez Morse, San Clemente, CA (US); Cooper Wyatt Morse, San Clemente, CA (US)

(72) Inventors: Jennifer Velasquez Morse, San Clemente, CA (US); Cooper Wyatt Morse, San Clemente, CA (US)

(21) Appl. No.: 18/134,478

(22) Filed: Apr. 13, 2023

Related U.S. Application Data
(60) Provisional application No. 63/330,714, filed on Apr. 13, 2022.

(51) Int. Cl. A01K 27/00

(52) U.S. Cl. CPC A01K 27/004; A01K 27/008

(57) ABSTRACT

A pet leash system includes a leash cord comprising a first end adapted to be connected to a pet and a second end. A housing can be connected to the second end of the leash, the housing having a handle portion with a handle opening adapted to receive at least a portion of the hand of a user so the user can grasp the handle. The housing comprises an accessory attachment mechanism on the housing adapted to carry one or more pet walk accessories in or on the housing. In one version, the housing includes a leash cord retraction mechanism.

### PRIORITY

The present application claims the benefit of domestic priority based on U.S. Provisional Patent Application 63/330,714 filed on Apr. 13, 2022, the entirety of which is incorporated herein by reference.

### BACKGROUND

While owning and caring for a pet can be one of the most rewarding experiences in a person's life, the act of walking the pet can sometimes be a frustrating one. This is especially true when additional items or accessories need to be carried by the pet walker.

Many pets, particularly dogs, need to be regularly walked in order to give the pet exercise and stimulation and to allow the pet to urinate and/or defecate. To walk a pet, a pet walker will often connect a leash to the pet's collar or harness to tether the pet and prevent the pet from running away from the pet walker. The leash typically has a connection end for connecting to the pet and an opposite end including a loop or handle that can be grasped by the pet walker. Difficulties can occur, however, when the pet walker needs use of his or her hands for other tasks and/or when additional items need to be carried during the pet walking activity. During the pet walk, the hands of the pet walker are usually preoccupied with holding the leash and controlling the pet. This can be problematic when items such as empty or full waste bags, hand sanitizer, portable water bowls or other accessories are needed to be carried on the walk.

Leashes or other systems for holding an item during a pet walk have been developed. However, the available systems have not proven to be satisfactory. For example, some systems are limited to holding one specific accessory and are thus not adaptable to different types of accessories. Some systems have accessory attachments in locations that are not convenient and/or that interfere with the holding of the leash or the control of the pet. There are also products that come in the form of a waist or fanny bag for holding an accessory. This is not only more costly in that multiple products must be purchased by the pet walker, but it is also easy for the pet walker to forget the additional item when a walk begins.

Therefore, there is a need for a pet leash system that easily and conveniently allows for the carrying of pet walk related accessories. There is further a need for a pet leash handle or housing that allows for the carrying of pet walk related accessories in or on the pet leash handle or housing.

### SUMMARY

The present invention satisfies these needs. In one aspect of the invention, an improved pet leash system is provided.

In another aspect of the invention, an improved pet leash handle or housing is provided.

In another aspect of the invention, a pet leash handle housing allows for the carrying of one or more pet walk related accessories in or on the housing.

In another aspect of the invention, a pet leash system comprises a leash cord comprising a first end adapted to be connected to a pet and a second end; and a housing connected to the second end of the leash, the housing having a handle portion comprising a handle opening adapted to receive at least a portion of the hand of a user so the user can grasp the handle, wherein the housing comprises an accessory attachment mechanism on the housing adapted to carry one or more pet walk accessories in or on the housing.

In another aspect of the invention, a pet leash system comprises a leash cord comprising a first end adapted to be connected to a pet and a second end; and a housing connected to the second end of the leash, the housing having a handle portion comprising a handle opening adapted to receive at least a portion of the hand of a user so the user can grasp the handle, wherein the housing comprises an accessory attachment mechanism on the housing adapted to carry one or more pet walk accessories in or on the housing, wherein the housing comprises a retraction mechanism adapted to allow the pet leash cord to be selectively retracted into and extended from the housing.

In another aspect of the invention, a pet leash system comprises a leash cord comprising a first end adapted to be connected to a pet and a second end; and a housing connected to the second end of the leash, the housing having a handle portion comprising a handle opening adapted to receive at least a portion of the hand of a user so the user can grasp the handle, wherein the housing comprises an accessory attachment mechanism on the housing adapted to carry one or more pet walk accessories in or on the housing, wherein the accessory attachment mechanism comprises one or more apertures that extend through the housing.

In another aspect of the invention, a pet leash system comprises a leash cord comprising a first end adapted to be connected to a pet and a second end; and a housing connected to the second end of the leash, the housing having a handle portion comprising a handle opening adapted to receive at least a portion of the hand of a user so the user can grasp the handle, wherein the housing comprises an accessory attachment mechanism on the housing adapted to carry one or more pet walk accessories in or on the housing, wherein the accessory attachment mechanism comprises a plurality of apertures associated with the housing.

In another aspect of the invention, a pet leash system comprises a leash cord comprising a first end adapted to be connected to a pet and a second end; and a housing connected to the second end of the leash, the housing having a handle portion comprising a handle opening adapted to receive at least a portion of the hand of a user so the user can grasp the handle, wherein the housing comprises an accessory attachment mechanism on the housing adapted to carry one or more pet walk accessories in or on the housing, wherein the one or more protrusions extend outwardly from a side wall of the housing.

In another aspect of the invention, a pet leash system comprises a pet leash cord comprising a first end adapted to be connected to a pet and a second end; and a housing connected to the second end of the leash, the housing having a substantially rigid body comprising a handle opening adapted to receive at least a portion of the hand of a user so the user can grasp the housing, wherein the housing comprises a plurality of apertures extending from one side of the housing to the other side of the housing, the plurality of apertures being adapted to carry one or more pet walk accessories in or on the housing.

In another aspect of the invention, a method of walking a pet comprises providing a pet leash system comprising a pet leash cord having a first end and a second end; connecting the first end of the pet leash cord to a pet; grasping the second end of the pet leash cord; and carrying one or more pet walk accessories on an accessory attachment mechanism on the pet leash system.

In another aspect of the invention, a method of walking a pet comprises providing a pet leash system comprising a pet leash cord having a first end and a second end; connecting the first end of the pet leash cord to a pet; grasping the second end of the pet leash cord; and carrying one or more pet walk accessories on an accessory attachment mechanism on the pet leash system, and further comprising providing a housing connected to the second end of the pet leash cord, wherein the housing has a housing body comprising a handle opening adapted to receive at least a portion of the hand of a user so the user can grasp the housing, and wherein the accessory attachment mechanism is on the housing.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic side view of a pet leash system of the present invention;

FIG. 2 is a schematic side view of another version of a pet leash system of the invention;

FIG. 3 is a schematic perspective view of the pet leash system of FIG. 2;

FIG. 4A is a schematic perspective view of another version of a pet leash system of the invention;

FIG. 4B is a partial schematic perspective view of another version of the pet leash system of FIG. 4A;

FIG. 4C is a partial schematic perspective view of another version of the pet leash system of FIG. 4A;

FIG. 5 is a schematic side view of another version of a pet leash system of the invention;

FIG. 6 is a schematic side view of another version of a pet leash system of the invention;

FIG. 7 is a schematic side view of another version of a pet leash system of the invention; and

FIG. 8 is a schematic perspective view of a pet leash system according to another version of the invention.

### DESCRIPTION

The present invention relates to a pet leash system. In particular, the invention relates to pet leash system that allows for the carrying of one or multiple pet walk related accessories. Although the invention is illustrated and described in the context of being useful for pet walking, such as dog walking, the present invention can be used in other ways, as would be readily apparent to those of ordinary skill in the art. Accordingly, the present invention should not be limited just to the examples and embodiments described herein.

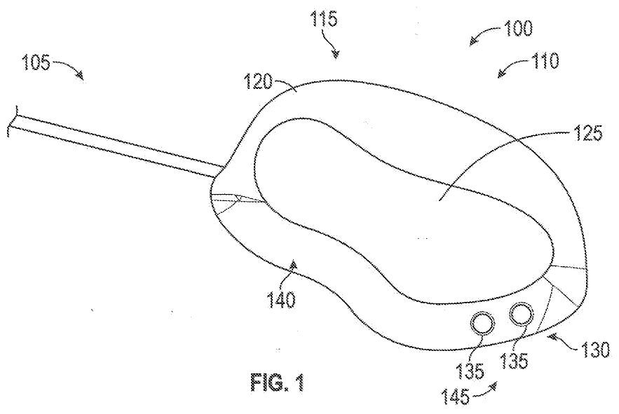

FIG. 1 shows a pet leash system 100 according to the invention. The pet leash system 100 includes a pet leash cord 105 that may be connected at one end to a pet in need of a walk or that needs to be otherwise controlled or retrained. While the pet to be walked will often be a dog that is to be walked by the dog's owner, caregiver, or assistant, by pet it is meant any animal that is to be walked or restrained whether or not the animal is owned or controlled by the pet walker and whether or not the animal is living, mechanical, robotic, or otherwise. The one end of the pet leash cord 105 will include a hook, clasp or the like as is conventionally known for connecting the pet leash cord 105 to the pet to be walked, such as by connecting to the pet's collar or harness. The pet leash cord 105 is can be flat or round and is generally flexible and can be made of conventional materials used for pet leashes. At the other end of the pet leash cord 105 and as shown in FIG. 1, the pet leash system 100 includes a housing 110 or handle that includes a graspable portion that is graspable by a pet walker who is or will be walking the pet. In the version of FIG. 1, the housing 110 includes a pet leash handle portion 115 on or as part of a housing body 120 of the housing 110. The housing body 120 or handle body has a handle opening 125 that is sized and shaped to receive at least a portion of the hand of the pet walker so that the pet walker and easily and securely hold the handle portion 115 at a graspable portion formed by the handle opening 125 to thereby control the pet during the pet walk.

As also shown in the version of FIG. 1, the pet leash housing body 120 also includes an accessory attaching mechanism 130. The accessory attaching mechanism 130 is designed to allow one or more pet walk related accessories to the carried and/or stored in or on the pet leash housing 110. For example, the pet walk related accessory can be one or more of an empty pet waste bag, a pet waste bag containing pet waste, hand sanitizer, sanitizing wipes, a portable water bowl, a container for snacks or treats, flashlight, reflector, pepper/citronella spray, whistle, small water container, keys or keychain, sunscreen, and the like. By being able to carry the one or more pet walk related accessories in or on the housing 110, the pet walker will not have to use a hand or other means to carry the accessory thereby freeing up the hands to carry other items and/or for controlling the pet. In addition, the pet walker can optionally store the one or more pet walk related accessory in or on the pet leash housing 110 when the pet leash housing 115 is not being used to assure that the one or more accessories are easily and readily available the next time the leash system 100 is to be used to walk a pet.

In the particular version of FIG. 1, the accessory attaching mechanism 130 comprises one or more apertures 135, such as a hole or opening, that extend into and/or through the housing body 120. For example, in the version shown, each of the one or more apertures 135 extends laterally at least mostly through and preferably entirely through the housing body 120 from a left side outer surface 140 to the opposite right side outer surface. In one version, the one or more apertures 135 extends substantially in the same direction as the handle opening 125 and transverse to the direction of the leash 105 as it extends from the housing body 120. In another version, the one or more apertures 135 extend in a different direction. Also, as in the version shown, the one or more apertures 135 is a plurality of apertures 145. By providing a plurality of apertures 145, a plurality of pet walk related accessories may be carried. Each of the apertures 135 in the plurality of apertures 140 can be the same or can be different and can extend in the same or in different directions.

The one or more apertures 135 may be sized and shaped to be adapted to carry a particular pet walk related accessory or to carry one of a variety of pet walk related accessories. For example, by providing an aperture that has a diameter or equivalent cross-sectional dimension of from about 0.125 inches to about 6 inches, or from about 0.25 inches to about 4 inches, or from about 0.33 inches to about 2 inches, or from about 0.5 inches to about 1 inch, the aperture 135 has the ability to be used in a variety of ways. For example, the aperture 135 can be used to hold a bag that has been inserted therethrough or can be used to carry a string, handle, or hook for a different accessory. By equivalent dimension herein and throughout it is meant that if the circular cross-section or shape were to be replaced with a non-circular cross-section or shape, the equivalent dimension would be the dimension of the non-circular cross-section or shape that results in an area calculation that is generally the same as the area of the circular cross-section or shape. By way of hypothetical example, a 1 mm diameter cross-section or circular shape would have an area of about 0.8 mm² and a square shaped cross-section or shape would have an equivalent cross-sectional area also of about 0.8 mm² which would mean the length of the sides of the square is about 0.9 mm. While the one or more apertures 135 are shown as being circular in cross-section, they can be any cross-sectional shape of equivalent dimension. For example, the one or more apertures 135 can be oval, ovoid, rounded, egg-shaped, square, rectangular, trapezoidal, any other polygonal shape, any other substantially polygonal shape that includes rounded portions, a combination of any of these shapes, or the like. While the one more apertures 135 can be located and positioned anywhere on the housing body 120, in one particular version, each of the one or more apertures 135 extends laterally through the housing body 120 from an opening in the left side outer surface 140 to an opening in the opposite right side outer surface. In this version, the one or more apertures 135 extends through the thickness of the housing body 120 and thus has a length from the left side opening to the right side opening of at least 0.1 inches at least about 0.2 inches or at least about 0.5 inches or at least about 0.75 inches.

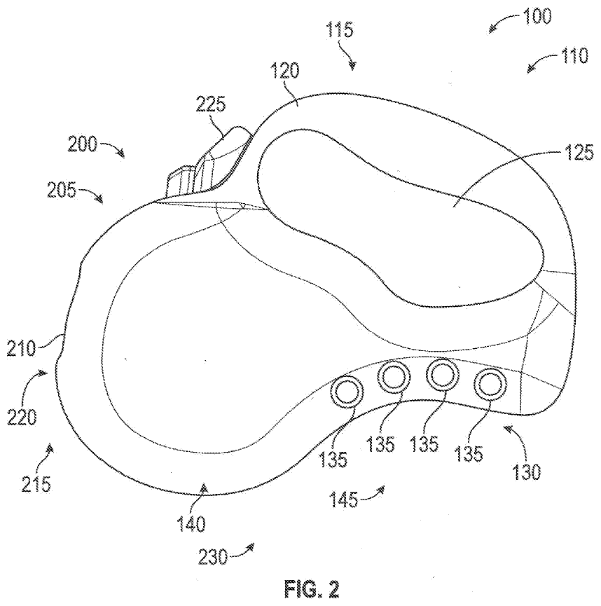

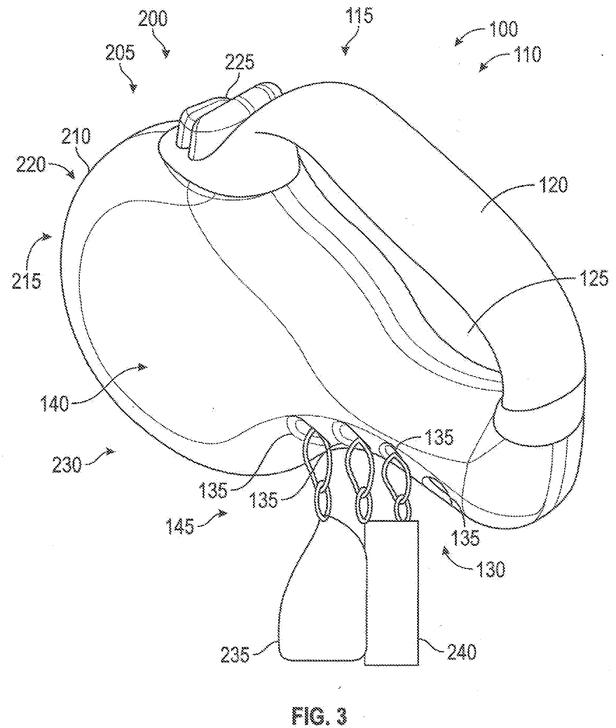

FIGS. 2 and 3 show another version of a pet leash housing 110 of a pet leash system 100 of the invention. In this version, the pet leash housing 110 is a retractable handle 200 that includes a retraction mechanism 205 within its interior. The pet leash cord 105 (not shown in FIG. 2 for clarity) extends from an opening 210 in the front 215 of the retractable handle 200. Internally, the pet leash cord 105 is wound around a retraction member 220 that is controlled by a button 225 that selectively allows the pet leash cord 105 to be extended or retracted. Retraction mechanisms 205 of the type shown are conventionally known in the art. The housing body 120 is made of a rigid or semi-rigid material sufficiently strong to support the retraction mechanism 205 and to handle the stresses applied during use of the pet leash housing 110. In one version, the housing body 120 comprises a hard outer shell made of polymer or the like, as is conventionally known.

As shown in FIGS. 2 and 3, the retractable handle 200 of the pet leash system 100 includes an accessory attachment mechanism 130 in that includes one or more apertures 135 as discussed in connection with FIG. 1. In the version, shown in FIGS. 2 and 3, the accessory attachment mechanism 130 includes a plurality of apertures 145, such as the four shown. The one or more apertures 135 may be positioned anywhere on the housing body 120. In the version of FIGS. 2 and 3, the one or more apertures 135 are positioned near the bottom of the housing body 120. In this location, the one or more apertures 135 can conveniently carry an accessory in a manner that does not interfere with the grasping and control of the pet leash system 100 by the pet walker or with the operation of the retraction mechanism 205. FIG. 3 shows the accessory attachment mechanism carrying a first accessory 235 and a second accessory 240.

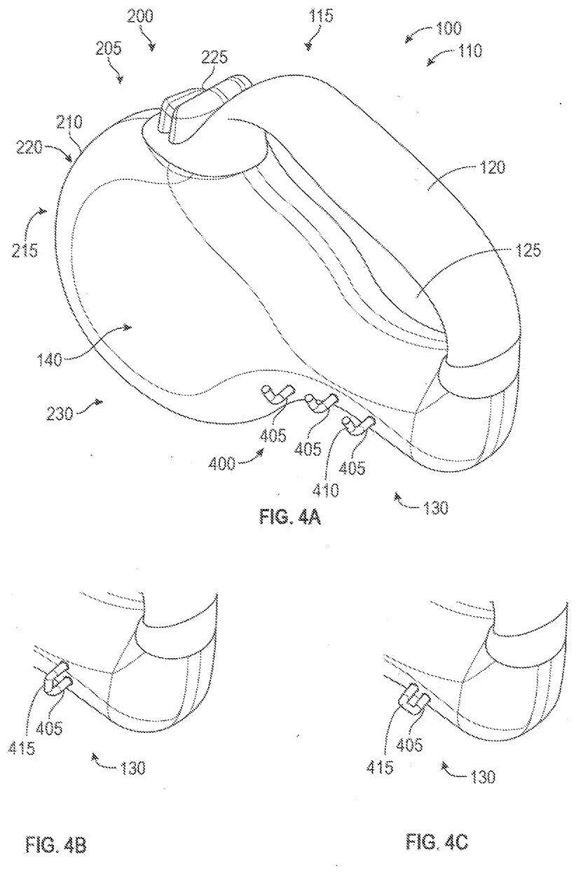

FIG. 4A shows another version of a pet leash system 100 of the invention. The version of FIG. 4A is similar to the version of FIGS. 2 and 3 except that in the version of FIG. 4A the accessory attachment mechanism comprises one or more protruding members 400, such as one or more hooks 405 that replace or are provided in addition to the one or more apertures 135. The one or more hooks 405 can include upwardly extending portions 410 or can extend straight out. The one or more pet walk accessories can be hooked onto a hook 405 or a handle or string for the accessory can be hooked onto a hook 405. In the version shown, the one or more hooks 405 extend laterally outwardly from the left side surface 140 and/or the right side surface of the housing body 120. FIG. 4B shows a variation of the version of FIG. 4A where the one or more hooks 405 is a closed ring 415 that extends substantially in the up and down direction to create an opening that extends substantially in the front to back direction of the housing body 120. FIG. 4C shows another version of the closed ring 415 with the closed ring 415 extending in a front to back direction to create an opening that extends in the up and down direction. Alternatively, the closed ring 415 can be an any angle between that which is shown in FIGS. 4B and 4C, and the closed rings can be located at other positions on the housing body 120 such extending downwardly from the bottom surface of the housing body 120.

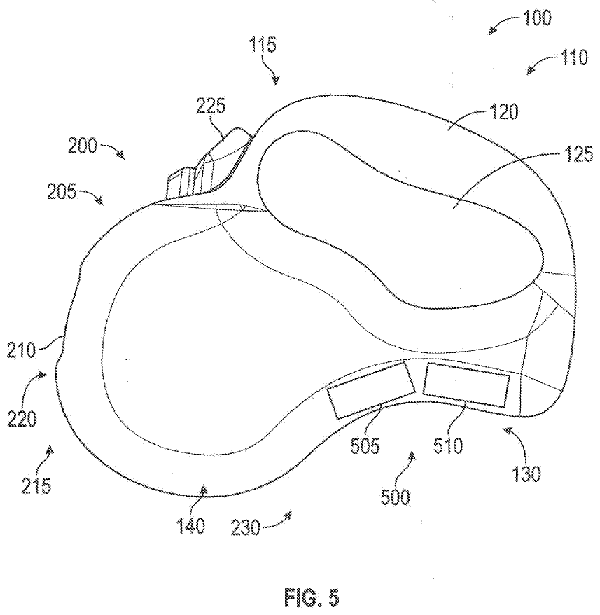

Another version of a pet leash system 100 is shown in FIG. 5. In this version, the accessory attachment mechanism 130 comprises one or more magnets 500 positioned on the housing body 120. For example, the one or more magnets 500 can be positioned on the left side surface 140 and/or on the right side surface so that an accessory can be attached to the side of the housing body 120. The accessory to be carried on the housing body 120 can be provided with a magnet or a magnetic surface that is attracted to the one or more magnets 500. In the version shown in FIG. 5, the one or more magnets 500 comprises a plurality of magnets, such as a first magnet 505 and a second magnet 510. Alternatively, a single magnet or more than two magnets can be provided. In an alternative arrangement, a magnet can be provided on the accessory and the accessory attachment mechanism 130 can comprises a magnetic surface that is attracted to the magnet.

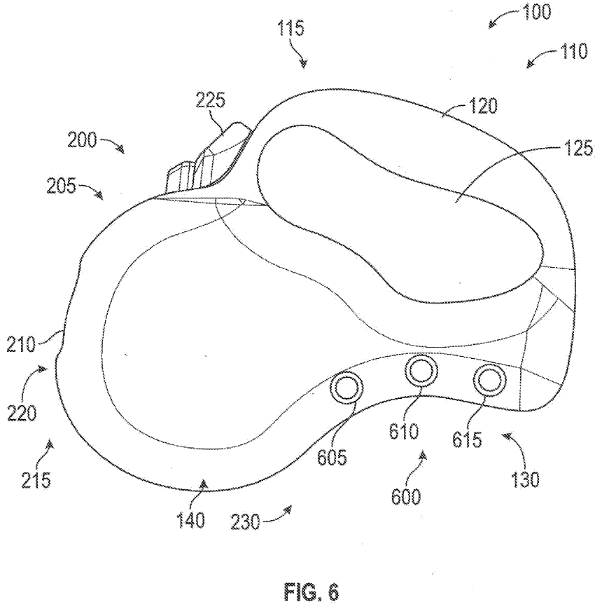

Another version of a pet leash system 100 is shown in FIG. 6. In this version, the accessory attachment mechanism 130 comprises one or more snaps 600 or buttons or the like positioned on the housing body 120. For example, the one or more snaps 600 can be positioned on the left side surface 140 and/or on the right side surface so that an accessory can be attached to the side of the handle body 130. The accessory to be carried on the housing body 120 can be provided with a mechanism that is engaged by the snaps 600 or buttons or the like. In the version shown in FIG. 6, the one or more snaps 600 or buttons or the like comprises a plurality of magnets, such as a first snap 605, a second snap 610, and a third snap 615. Alternatively, a single snap or two snaps can be provided or more than three can be provided. In an alternative arrangement, a snap or button or the like can be provided on the accessory and the accessory attachment mechanism 130 can comprises a member that receives the snap or button or the like.

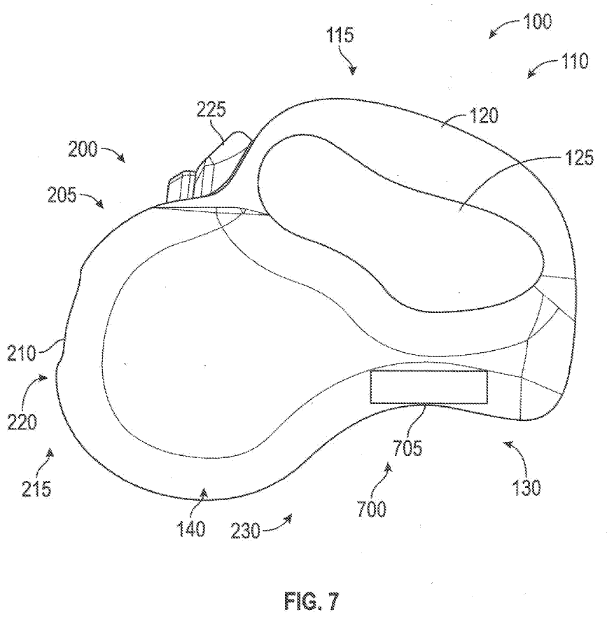

Another version of a pet leash system 100 is shown in FIG. 7. In this version, the accessory attachment mechanism 130 comprises one or more Velcro or other type of hook and loop fastener system 700 positioned on the housing body 120. For example, one side 705 of a hook and loop fastener 700 can be positioned on the left side surface 140 and/or on the right side surface so that an accessory can be attached to the side of the handle body 130. The accessory to be carried on the housing body 120 can be provided with the corresponding side of the hook and loop fastener system 700. In the version shown in FIG. 7, a single strip of the one side 705 is provided. One or more corresponding strips can be attached to the single strip. Alternatively, multiple first side strips 705 can be provided.

With any of the aforementioned versions, the number and location of the accessory attachment mechanisms can be anywhere on the housing body 120. Any combination of the types of the accessory attachment mechanisms can also be provided. Also, in a version of the invention, the accessory attachment mechanism can be located on a member that is removably attachable to the housing. The member can be attachable to the housing by a screw type arrangement, a sliding arrangement, a press-fit arrangement or the like. Also the handle portion can be removably attachable to the housing and/or can include an indentation or the like in place of a complete opening.

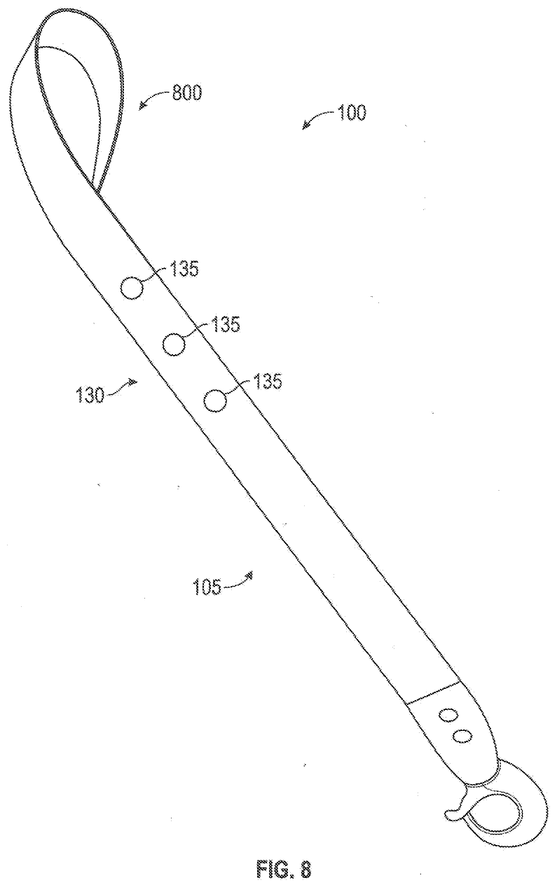

FIG. 8 shows another version of the pet leash system 100 where pet leash system 100 is a leash-cord-based pet leash system 800. In the version of FIG. 8, the graspable portion 110 of the pet leash system 100 comprises a loop 805 of the pet leash cord 105, but it could alternatively also have a handle, such as a conventional retractable handle or other housing. The accessory attachment mechanism 130 is provided on the pet leash cord 105 itself, such as by being built in rings on the leash to easily attach accessories. The accessory attachment mechanism 130 of the version of FIG. 8 can be any of the accessory attachment mechanisms discussed above or a combination thereof.

Although the present invention has been described in considerable detail with regard to certain preferred versions thereof, other versions are possible, and alterations, permutations and equivalents of the version shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” and their variations such as “consists” should be understood to imply the inclusion of a stated element, limitation, or step and not the exclusion of any other elements, limitations, or steps or any other non-essential elements, limitations, or steps, respectively. Throughout the specification, any discussed on a combination of elements, limitations, or steps should be understood to include a disclosure of additional elements, limitations, or steps and the disclosure of the exclusion of additional elements, limitations, or steps. All numerical values, unless otherwise made clear in the disclosure or prosecution, include either the exact value or approximations in the vicinity of the stated numerical values, such as for example about +/−ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A pet leash system comprising:
a leash cord comprising a first end adapted to be connected to a pet and a second end; and
a housing connected to the second end of the leash, the housing having a handle portion comprising a handle opening adapted to receive at least a portion of the hand of a user so the user can grasp the handle,
wherein the housing comprises an accessory attachment mechanism on the housing adapted to carry one or more pet walk accessories in or on the housing.

2. A pet leash system according to claim 1, wherein the housing comprises a retraction mechanism adapted to allow the pet leash cord to be selectively retracted into and extended from the housing.

3. A pet leash system according to claim 1, wherein the accessory attachment mechanism comprises one or more apertures that extend through the housing.

4. A pet leash system according to claim 1, wherein the accessory attachment mechanism comprises one or more apertures that extend at least about 0.5 inches into or through the housing.

5. A pet leash system according to claim 1, wherein the accessory attachment mechanism comprises a plurality of apertures associated with the housing.

6. A pet leash system according to claim 1, wherein the accessory attachment mechanism comprises a plurality of apertures that extend laterally relative to the housing.

7. A pet leash system according to claim 1, wherein the accessory attachment mechanism comprises one or more protrusions that extend outwardly from the housing.

8. A pet leash system according to claim 7, wherein the one or more protrusions extend outwardly from a side wall of the housing.

9. A pet leash system according to claim 7, wherein the one or more protrusions comprises one or more hooks.

10. A pet leash system according to claim 7, wherein the one or more protrusions comprises one or more closed rings.

11. A pet leash system according to claim 1, wherein the accessory attachment mechanism comprises one or more magnets.

12. A pet leash system according to claim 1, wherein the accessory attachment mechanism comprises one or more snaps or buttons.

13. A pet leash system according to claim 1, wherein the accessory attachment mechanism comprises a hook and loop fastener system.

14. A pet leash system according to claim 1, wherein the accessory attachment mechanism is on a member that is removably attachable to the housing.

15. A pet leash system comprising:
a pet leash cord comprising a first end adapted to be connected to a pet and a second end; and
a housing connected to the second end of the leash, the housing having a substantially rigid body comprising a handle opening adapted to receive at least a portion of the hand of a user so the user can grasp the housing,
wherein the housing comprises a plurality of apertures extending from one side of the housing to the other side of the housing, the plurality of apertures being adapted to carry one or more pet walk accessories in or on the housing.

16. A pet leash system according to claim 15, wherein the housing comprises a retraction mechanism adapted to allow the leash to be selectively retracted into and extended from the housing.

17. A pet leash system according to claim 15, wherein the plurality of apertures extend at least about 0.5 inches through the housing.

18. A method of walking a pet, the method comprising:
providing a pet leash system comprising a pet leash cord having a first end and a second end;
connecting the first end of the pet leash cord to a pet;
grasping the second end of the pet leash cord; and
carrying one or more pet walk accessories on an accessory attachment mechanism on the pet leash system.

19. A method according to claim 18, further comprising providing a housing connected to the second end of the pet leash cord, wherein the housing has a housing body comprising a handle opening adapted to receive at least a portion of the hand of a user so the user can grasp the housing, and wherein the accessory attachment mechanism is on the housing.

20. A method according to claim 18 wherein the pet walk accessory comprises one or more of an empty pet waste bag, a pet waste bag containing pet waste, hand sanitizer, sanitizing wipes, a portable water bowl, a container for snacks or treats, flashlight, reflector, pepper, spray, citronella spray, whistle, small water container, keys or keychain, sunscreen.
